(19) United States
(12) Patent Application Publication
(10) Pub. No.: US 2008/0258051 A1
(43) Pub. Date: Oct. 23, 2008

(54) Equipment and Process for Measuring the Precision of Sun Tracking for Photovoltaic Concentrators

(75) Inventors: Ignacio Luque Heredia, Madrid (ES); Goulven Quemere, Madrid (ES); Rafael Cervantes Saldana, Almeria (ES)

Correspondence Address: THE MUELLER LAW OFFICE, P.C., 12951 Harwick Lane, San Diego, CA, 92130, US

(73) Assignee: SolFocus, Inc., Mountain View, CA (US)

(21) Appl. No.: 12/101,941

(22) Filed: Apr. 11, 2008

(30) Foreign Application Priority Data
Apr. 11, 2007 (ES) P200700959

(51) Int. Cl. G12B 13/00; G01C 21/02

(52) U.S. Cl. 250/252.1; 250/206.1

(57) ABSTRACT

Mechanical sun trackers which have optical systems on their surface for concentrating direct solar radiation and its subsequent conversion into electricity through thermal or photovoltaic processes require precision solar tracking, which has to be all the more precise the greater the concentration factor used. Thus the precision required in these systems is generally less than a degree, and frequently of the order of a tenth of a degree. In view of the large dimensions of the surfaces, or apertures, of these trackers, currently in the approximate range of 20-250 m², the difficulty of aligning these with the sun with such accuracy will be obvious. To achieve this objective a solar tracker must comply with strict rigidity specifications and its transmission must provide high resolution when positioning. In addition to this, equipment which is capable of controlling solar tracking with the specified precision at all times is required.

### RELATED APPLICATIONS

This application claims priority to Spanish Patent Application No. P200700959 filed on Apr. 11, 2007 entitled “Equipment and Process for Measuring the Precision of Sun Tracking for Photovoltaic Concentrators,” which is hereby incorporated by reference as if set forth in full in this application for all purposes.

### DESCRIPTION

This invention relates to Equipment for Measuring the Precision of Sun Tracking in two-axis Photovoltaic Concentrators.

### BACKGROUND TO THE INVENTION

Mechanical sun trackers which have optical systems on their surface for concentrating direct solar radiation and its subsequent conversion into electricity through thermal or photovoltaic processes require precision solar tracking, which has to be all the more precise the greater the concentration factor used. Thus the precision required in these systems is generally less than a degree, and frequently of the order of a tenth of a degree. In view of the large dimensions of the surfaces, or apertures, of these trackers, currently in the approximate range of 20-250 m², the difficulty of aligning these with the sun with such accuracy will be obvious. To achieve this objective a solar tracker must comply with strict rigidity specifications and its transmission must provide high resolution when positioning. In addition to this, equipment which is capable of controlling solar tracking with the specified precision at all times is required.

The maximum sun tracking error which can be permitted without a significant change in the electrical power delivered is known as the angular aperture of the photovoltaic concentrator. This potential drop threshold which defines the angular aperture is usually set at 90-95%. The fundamental rule in the design of a photovoltaic concentrator in terms of the sun tracking operation is that the angular aperture should be greater than the precision of pointing for any orientation of the sun tracker. Failure to achieve this objective may render the design non-viable, and it is therefore very important to have equipment and methods capable of measuring the instantaneous precision of the pointing of a photovoltaic concentrator which will be used as a basis for generating pointing error statistics.

Up to now there have been hardly any references relating to instrumentation and methods of measurement for a photovoltaic concentrator. Photovoltaic concentration is still at a preliminary stage of industrial application and most of the protagonists of these developments do not provide any explanations as to how or with what instruments the precision of pointing of their prototypes is measured, which in general is an indication that the values provided in this respect are usually not very rigorous estimates. Thus a theoretically viable method for measuring pointing error at a given time would be to maneuver the concentrator until its output potential is maximized, after which control is passed to the automatic sun tracking, and if this tracking control acts in a way in which this transition is rapid and does not require the prior detection of rotational reference marks, the angular difference between the two positions, the initial position of maximum power and the final tracking position in the two axes of rotation, it will provide us with an estimate of the error. Using these two angles it is possible to obtain the error angle between the tracking orientation and the maximum power orientation for that particular instant, provided that a number of geometrical parameters characterizing the concentrator installation and the construction of the solar tracker on which it is mounted (orientation of the primary axis with respect to the ground, the secondary axis with respect to the primary, the maximum power orientation with respect to the secondary axis, and the rotational references on the axes) are known. These parameters are not easy to determine by direct measurements, and can only be obtained accurately indirectly through the adjustment of error models, although in any event the two angles mentioned are already an indicative measure of the pointing error. However, as mentioned, these are clearly acquired manually and it is difficult to obtain a significant number, and even then not very accurately, fundamentally because of the difficulty of positioning the concentrator in the maximum power orientation, and in any event this requires direct or indirect measurement of the rotational angles of the axes.

As far as the instrumentation specifically developed for measuring the pointing error in solar trackers is concerned, such as is required by photovoltaic concentrators, the only previous reference is in the work of Galbraith for the Sandia National Laboratories of the United States (Galbraith, G. “Development and Evaluation of a Tracking Error Monitor for Solar Trackers”, Technical Report SAND88-7025, Sandia National Laboratories, 1988). This is based on the differences between the currents photo generated in a pair of photovoltaic cells, both polarized in short circuit, installed at a particular inclination within a closed tube whose upper cover has an aperture such that when the axis of the tube is pointed in the vicinity of the sun a collimated beam of sunlight of sufficient cross-section to illuminate the two photovoltaic cells passes through said holes. Only when the beam is incident on the surfaces of the photovoltaic cells at the same angle are the photo generated currents the same, and regardless of the angle at which the two cells are mounted this occurs when said beam is approximately parallel to the axis of the collimating tube. From the difference in the currents generated by the two cells it is mathematically possible to obtain the angle between the orientation of the sensor at the time and that other angle for which the currents are equal. The sensitivity of the changes in current with the angle of incidence of the collimated beam on their surfaces will depend on the angle at which the two cells are mounted. If this sensor has been specifically designed to measure precision of pointing in photovoltaic concentrators, the resolution measured in their prototypes is 0.02°, which was quite sufficient for the state of the art of the concentrators in existence at the time of its development but is now insufficient for measuring precision of pointing of the order of a tenth of a degree or less which the present very high concentration systems may require. On the other hand, for measuring pointing errors in a two-axis concentrator it is necessary to mount two systems as described with accurate orientation with respect to these axes, which is quite a complicated task.

Other antecedents which are worthy of mention, as their application is similar in some respects and benefits from the most modern digital image devices such as CCD and CMOS strips and matrices are the sun position sensors incorporated in the systems for orientating and maneuvering artificial satellites (Zabiyakin, A. S., Prasolov, V. O., Baklanov, A. I. Eltsov, A. V., Shalnev, O. V. “Sun Sensor Orientation and Navigation Systems of the Spacecraft”, Proceedings—SPIE the International Society for Optical Engineering, 3901, pp. 106-111, 1999 and Chum, J., Vojta, J., Base, J. Hruska, F. “A Simple Low Cost Digital Sun Sensor for Micro-Satellites” Small Satellites for Earth Observation ed. RöSer, H.-P., Sandau, R.; Valenzuela, A., Wissenschaft und Technik Verlag, 2003, Berlin). Nevertheless despite the high density of the CCD matrices used in these sensors, which require a very broad range of view, generally hemispherical (±90°), the accuracy which is obtainable from these devices is generally of the order of 0.05°-0.01°, which is again less than that required for measuring the precision of pointing in modern photovoltaic concentrators.

### DESCRIPTION OF THE INVENTION

This invention relates to an electronic system for measuring the tracking precision of two-axis photovoltaic concentrators, and measurement procedures for use therewith.

### Physical Description of the Pointing Sensor

Essentially the system is based on a sensor measuring precision of pointing, which is connected to the data acquisition system based on a computer.

The pointing sensor is based on a PSD (Position Sensitive Device) sensor, a monolithic optoelectronic device whose main usefulness is that it continuously measures the position of a point of light, such as that produced by the incidence of a collimated beam, on its surface. This function is achieved without the need to set up a matrix of individual sensors as in the case of CCD sensors currently used in digital image capturing systems. Use of sensors of this type for this function requires processing of all the measurements from these small cells, which ultimately slows down the rate with which measurements are transmitted. The principle of the operation of a PSD is wholly analog, and based on a PIN photodiode, which in its front P-type layer on which the light is incident has a pair of electrodes at its extremities, and only one electrode in the rear N-type layer. When a point of light is incident on the surface of each upper electrode a photocurrent which is inversely proportional to the distance of said point of incidence will flow in each upper electrode. Thus with a planar PSD and four electrodes suitably located on its outer perimeter it is possible to determine the Cartesian coordinates of the point of light with respect to a reference system centered on the surface of the PSD using the currents measured at the four electrodes. The ease of processing required for these measurements permits a very high sampling rate in the associated measurement acquisition system.

The sensor measuring precision of pointing is completed by placing said PSD device within a collimating tube, which comprises a tube of a specific length which has a cover at one end and in that cover there is a small open orifice through which, when it is orientated on the sun, a fine beam of light passes and strikes the surface of the PSD sensor located at the other end of the tube in a plane perpendicular to the axis of the tube. Knowing the position of the collimator orifice with respect to the origin of the PSD coordinates it is possible to calculate the angle of the collimated beam with respect to the axis of the sensor, which is understood to be the straight line passing through the origin of the sensor coordinates and the centre of the orifice in the collimator, from the coordinates of the point at which the beam struck. This angle is precisely the angle by which the sensor is misaligned with respect to the local earth-sun vector. The field of view or angular aperture of the sensor is understood to be the maximum misalignment angle which can be measured using the sensor, and this will be smaller the longer the tube, so that beyond a particular length this relationship will be one of inverse proportionality. Conversely the resolution in the measurement of the misalignment angle will be greater the greater the length of the collimator tube.

Resolution, sensitivity to assembly errors and method of calibrating the pointing sensor.

Continuing with this process of designing the sensor it is possible to achieve resolutions in measurement of the sun misalignment angle of the order of a thousandth of a degree, and even a ten thousandth with high light intensities, using relatively large apertures of the order of ±1°. This is because of the very high measurement resolution of the PSD device, which is frequently of the order of a micron. The relationship between the point of incidence of the collimated beam and the misalignment angle includes among its parameters the coordinates of the collimator orifice with respect to the origin of the PSD coordinates. If we consider these coordinates cylindrically, while the height is directly equal to that of the collimator tube, the azimuth and elevation angles will be difficult to measure in a particular assembly, or conversely it will be difficult to construct the sensor in such a way that these two angles are consistent with values fixed at the outset, so it is important that the error arising when a particular value for these two angles is assumed, for example zero, is as small as possible. However the length of collimator which is required in practical embodiments is sufficiently great for the error in measurement of the misalignment angle to be of the order of the resolution in the measurement, and therefore not significant, even when the collimator is placed on the PSD at the limit at which the angular aperture of the sensor is cancelled out. Likewise, in these practical embodiments, for the errors in the orifice coordinates, in other words in the collimator, which are used in the expressions for converting the PSD coordinates to the misalignment angle, to exceed the resolution of measurement in this angle, they must be of the order of a millimeter, which can easily be checked during the construction and mounting of the sensor. All of this is to indicate the advantage of the design of the sensor described, and the wide tolerance applying to its mounting.

Notwithstanding all this, if new PSD models have significantly greater resolutions and it is necessary to know accurately the position of the collimator orifice with respect to the origin of the PSD resulting from a particular assembly, this can be discovered from the lines which the collimated beam describes on the surface of the PSD when with the pointing sensor mounted on a solar tracker it is caused to rotate about one of its axes. By measuring the gradients and the intersects of a number of these straight lines with the axes of the PSD's sensor it is possible to obtain the coordinates of the collimator orifice with respect to the origin of the PSD coordinates using a least squares adjustment of a function based on the gradients and intersects with the axes of the PSD, a geometrical function which characterizes the straight lines traced in relation to the two parameters of the rotational axis used and the coordinates of the collimator orifice.

### Auxiliary Electronics for the Pointing Sensor

The pointing sensor is supplemented by incorporated auxiliary electronics for processing the signal generated by the PSD. Various possibilities arise in this respect, from analog processing of the measurements originating from the two axes of the PSD for robust transmission to, for example, automatic data acquisition equipment (data-logger) or a PC provided with a data acquisition card, in both cases equipped with analog-digital conversion channels, or to ensure transmission and more sensitive reading in a conventional PC the PSD measurements can be sampled and digitized for subsequent conversion to a series transmission protocol, e.g. RS-232, 422 or 485. In addition to this it will be necessary to incorporate the DC power sources required to feed these auxiliary electronics.

Whichever these functions are chosen for the auxiliary electronics, the embodiment proposed will incorporate the PSD in the printed circuit of the auxiliary electronics and in turn this printed circuit board will be located within a leak-tight enclosure within the collimator tube positioned on the PSD. This enclosure will be provided with connectors for both the AC power supply, for power from the mains, and connectors for extracting the measurements via a series line or through at least two analog channels.

### Measurement Procedures

Provision is made for two procedures for measuring pointing precision depending, upon whether the pointing sensor is used as a virtual pointing vector for the concentrator, thus being used to evaluate the performance of the sun tracking controls with power feedback, or whether the conversion ratios for the sensor are calibrated directly against the maximum concentrator power and are used to measure the actual pointing precision relating to this power maximum.

### Procedure for Evaluating Tracking Controls with Feedback

In the first case it is a question of using it to evaluate the precision of pointing which can be achieved through the electronic equipment responsible for controlling tracking of the sun by two-axis photovoltaic concentrators, the so-called tracking control equipment, and more specifically the latest generation equipment. This is based on the internal computing of high accuracy solar ephemerises in digital processors, to which there is added a subsequent stage of conversion of the coordinates provided by these ephemerises into angles of rotation of the tracking axes corresponding to direct measurements of the position of the sun with respect to said axes of rotation through measuring the maximum power output. Such control equipment is occasionally referred to as being hybrid, because an open loop technique such as that used as the only source of references for positioning the coordinates generated by the ephemerises is conjugated with a closed loop which incorporates a feedback loop which measures the output power of the photovoltaic concentrator, or any equivalent approximation thereto, using the specific electrical output of the photovoltaic generator as a sensor of the sun's position.

In such circumstances the pointing sensor can be used as a virtual power output of the concentrator, that is assuming that the concentrator's pointing vector is identical to the sensor's pointing vector, or in other words that the maximum power output of the concentrator is produced by definition when the sensor records a null pointing error. This is useful because in the hybrid control strategies which are most effective at the present time, such as those based on a mathematic model of errors, also referred to as being self-calibrated, by analogy with the techniques used by large astronomical observatories, they are calibrated, or in more specifically mathematical terms are adjusted, through a series of precise alignments, to a star whose ephemerises are known with accuracy, in this case the sun, the calibration in this case being carried out assuming accurate pointing which cancels out the pointing sensor error. In general pointing the pointing sensor with precision is more sensitive, quicker and ultimately more free of errors than pointing a concentrator until the power output is maximized, and this is why it is useful when evaluating a strategy for sun tracking based on an errors model, and in particular in order to evaluate the precision and effectiveness of said model, to adjust it to a set of measurements which are as precise and as free of errors as possible in such a way that subsequent monitoring of the change in the pointing error exposes the weaknesses in the errors model used, apart from the fact that it is effected by errors in the measurements used for adjustment which in this case are extremely low. This monitoring of the pointing error, or the position of the collimated beam on the surface of the PSD, will produce statistics whose fundamental parameters can be associated with particular defects in tracking control. For example, the mean of the probability density of the position of the collimated beam on the plane of the PSD is related to the intrinsic precision of the solar ephemerises and the subsequent stage of conversion by the calibrated errors model into rotational angles about the tracking axes. On the other hand the typical deviation for this probability density may be associated with defects in positioning of the concentrator, deriving from mechanical transmissions with excess play, accentuated at points of tensile/compressive equilibrium, or defective control of the rotation speed of the axes when approaching the reference positions.

### Process for Measuring Precision of Pointing

The second application of the sensor for the precision of pointing is a canonical one, that is measurement of the precision of pointing a photovoltaic concentrator, in which its misalignment angle at any moment is taken to be that separating it from the orientation in which the electrical power produced by the concentrator is a maximum. Unlike the previous case in which tracking control equipment was calibrated against the pointing sensor, using this as the virtual power output to evaluate the effectiveness of the so-called hybrid tracking control strategies, in this case it will be the pointing sensor which is calibrated against the orientations which generate the maximum electrical power from the concentrator at any moment. In order to do this it must be borne in mind in the first place that photovoltaic concentrators are mounted on relatively large tracking structures so as to be able to support collection surface areas of the order from 20 to 250 m², which are to some extent subject to deformation such as flexion or torsion. It is because of this deformation that the relative positions of what we can call the sensor pointing vector, that is the one which passes through the origin of the PSD coordinates and the collimator orifice and when aligned with the local sun vector causes the collimated beam to strike said origin for the coordinates, and the so-called pointing vector of the concentrator, which is that which when integral with the collection surface area and rotating with it about the tracking axes produces the maximum electrical power in the concentrator when aligned with the solar vector, will not remain constant. In fact they will vary with the orientation of the tracker because of its inherent weight of the variable loads—basically the wind load—to which the concentrator is subject, deforming the collecting surface. Thus in order to measure the concentrator pointing with precision a necessary prior step is to know the relative position of the concentrator's pointing vector with respect to the sensor's pointing vector for the different orientations in which the sun is tracked. In principle this calibration is only feasible if it is made in the absence of wind, so that it depends only on the orientation of the structure, since if the wind parameter is introduced, apart from complicating the measuring system, it would be difficult to obtain an explicit function because of the dynamic effects of the wind, a function which would have to be incorporated in real time, making it difficult to use. For this reason measurements of pointing precision made in the presence of a variable wind load will be affected by noise insofar as these derive from deformations in the structure and because this changes the calibration obtained when at rest. In addition to this source of error, calibration will be carried out for a set of orientations determined by rotation of the collection surface about the two tracking axes. Thus the concentrator will be pointed at the sun until the output power, or an equivalent of this, is maximized, manually, for example by directly maneuvering the axes so as to maximize the readings from a multi meter, or automatically using a search routine for the sun tracking space until the readings from a data acquisition system are maximized. Once this maximization has been achieved the coordinates of the point of incidence of the collimated beam on the surface of the PSD are recorded, and the process is subsequently repeated over a period covering the greatest range of orientations possible. These points associated with different orientations represent relative positions of the sensor's pointing vector and the concentrator's pointing vector so that whenever the concentrator passes through this orientation the concentrator's precision of pointing is measured during calibration, the precision of pointing will have to be measured with respect to the already-known relative position of the concentrator pointing vector on the PSD. In other words, the origin of the coordinates of the PSD in each orientation is converted to the point recorded for this, and it is with respect to this origin that the misalignment of the concentrator must be calculated. There is no doubt that this reference point will only be determined for a discrete set of orientations, given that for orientations close to the measurements it will be necessary to determine the corresponding origin of the coordinates by interpolating between nearby points. This procedure, which may require calibrations every few days to generate points with respect to those which have to be interpolated until the six-months' cycle between solstices is completed is very much simplified in the case of a concentrator which tracks using azimuth and elevation axes, this being a so-called pedestal tracker in which the collection surface is mounted on an electromechanical transmission which provides it with two tracking axes, which are in turn mounted on a vertical structural pedestal. The reason for this lies in the vertical nature of the azimuth axis, and because of the necessary perpendicularity between the two axes the fact that the elevation axis is permanently horizontal, which acts in such a way that the inherent weight of the concentrator is centered on the pedestal, which is under compression only, and the only deformation possible is due to warping, which with the normal dimensions of the pedestal is unlikely to occur. Even in the case where the inherent weight of the concentrator is displaced with respect to the pedestal the effect should be minimum with normal dimensioning of the structural elements of which the pedestal is built. Thus in the case of a concentrator using a pedestal tracker the points recorded on the surface of the PSD during calibration will trace the same straight line regardless of the day on which this is carried out, while in the case of other configurations of the tracking axes the calibration points will not always fall on the same straight line, and it can only be hoped that they lie within the region bounded by the PSD plane. Because of this one day will be sufficient to calibrate the sensor against the maximum concentrator power, although this can only be carried out for the complete range of solar tracking elevations at the summer solstice, and therefore the closer the calibration day is to this ephemeris the more complete it will be.

### BRIEF DESCRIPTION OF THE DRAWINGS

In order to supplement the description provided and to assist better understanding of the characteristics of the invention a detailed description of a preferred embodiment will be provided based on a set of diagrams and flow diagrams accompanying this description, forming an integral part thereof, and in which the following are represented purely by way of orientation and without restriction:

FIGS. 1 and 2 show two complete views of the pointing sensor, an inner one and an outer one respectively.

FIGS. 3 and 4 show in cross-sectional view and in exploded view all the components with their corresponding numbered labels which are mentioned in the preferred description provided in the following section.

FIG. 5 shows a view of a photovoltaic concentrator mounted on a two-axis tracker, on which the fundamental sensors for monitoring the precision of sun tracking, or the evaluation of self-calibrated sun tracking control equipment, are also shown with their numbered labels which are referred to in the preferred description provided in the next section.

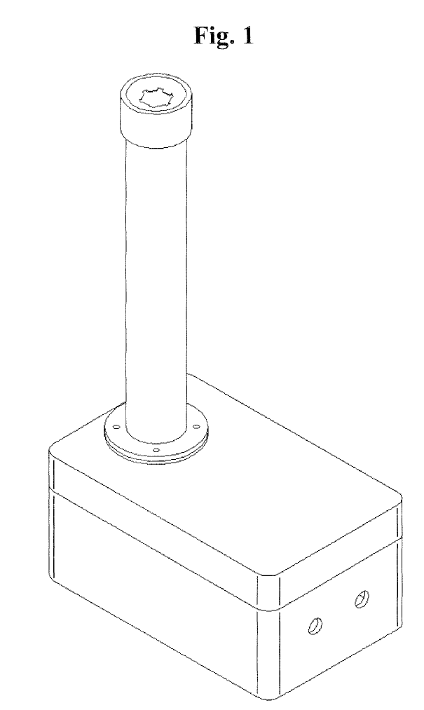

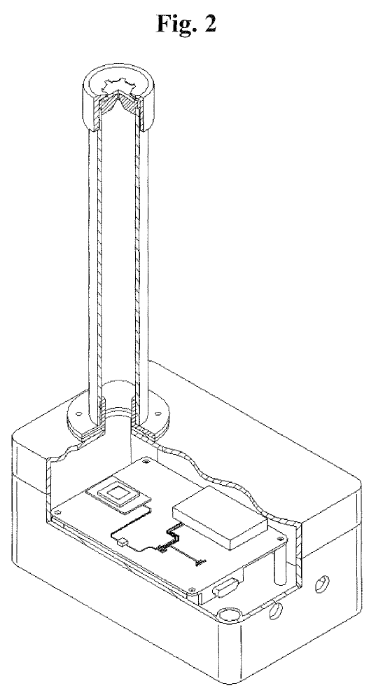

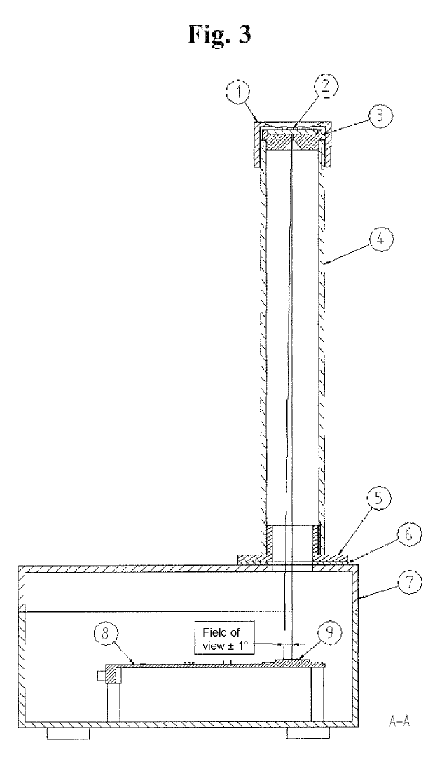

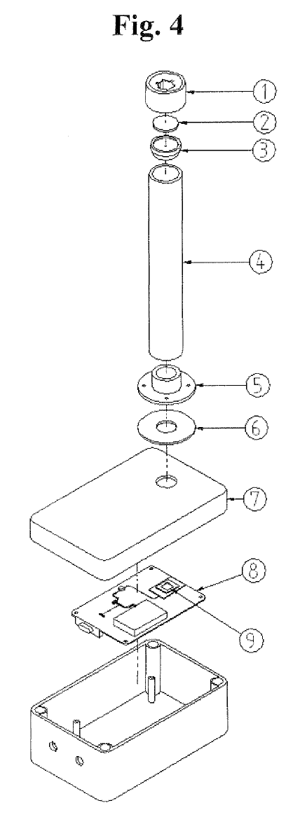

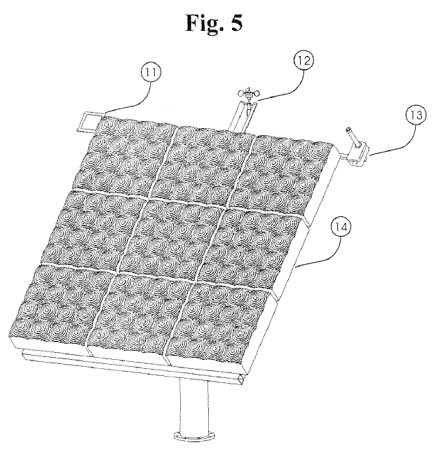

### DESCRIPTION OF A PREFERRED EMBODIMENT OF THE POINTING SENSOR

A preferred embodiment of the Measuring Equipment for the Precision of Sun Tracking will have the following fundamental physical constituents:

### A PSD Sensor of the Planar Type (9)

A cylindrical tube, referred to as a collimator tube (4) which is closed at its upper end by a cover having a central orifice which when orientated towards the sun's disc allows a fine beam of light to pass through it. The tube will be of a length such that it maintains a distance between the orifice and the surface of the PSD sensor so that the field of view of the sensor is at least ±1. The collimator will have to have its inner surface painted black in order to avoid false measurements due to reflection at the inner walls collimated with angles of incidence greater than its field of view. In addition to this, perforated disks which are concentric with the axis of the collimator tube and whose outer perimeter is attached to the inner wall of the tube may be provided so that they still further restrict possible reflections and false measurements which might derive therefrom.

The cover closing off the collimator tube comprises two parts:
a. The filter-bearing cover (3) which is the first in proximity to the PSD surface and threaded to the inner surface of the collimator tube at its upper end. This is the part which acts as the collimator orifice proper, and whose upper surface is machined to permit an optical filter (2) with 25% transmittance to be fitted so that the light intensity reaching the surface of the PSD is reduced below the saturation threshold of the PSD sensor. The filter is flush with the top edge of the part. The orifice made is also further countersunk in the lower surface of the filter-bearing cover in such a way that the thickness of the wall through which the orifice passes is as small as possible and does not restrict the collimator's field of view.
b. The cover (1), which is threaded on its inner surface and screws on to the outer wall of the collimator tube. This is mounted on the filter-bearing cover holding the filter in its cavity. In its lower surface it has a circular opening with an edge of inverted frustoconical profile so that the edges are reduced and pooling of rainwater on the filter, which may give rise to deposits of dirt, is made difficult. In addition to this, these smoothed edges make it easier to clean the surface of the filter. Finally the edge of the circular opening in the cover has machine-cut channels about its perimeter which also help to drain off water accumulating on the surface of the filter, channeling it to the outer wall of the collimator tube.

Surrounding the sensor is a box with a cover (5) and a leaktight closure for that cover (at least IP-66). In the cover there is a circular hole of a diameter slightly less than that of the collimator tube and an adaptor (7) is fitted over this hole, fixing the collimator tube to the cover using the inner thread which that tube has at its lower extremity to the inner surface thereof, all in such a way that the hole in the cover and the collimator tube are concentric. Between the adaptor and the cover there is fitted a rubber seal (6) which makes the joint between the two parts leaktight.

The printed circuit board (8) which contains the PSD sensor and the measurement electronics controlling the signal, digitization and management of the communications line is mounted within the enclosure. This board is mounted on a plane parallel to that of the cover in such a way that the plane of the PSD sensor is perpendicular to the axis of the collimator tube mounted on the cover. The PSD will be mounted on the printed circuit board in such a way that it lies below the collimator tube and its axis passes through its centre.

The sensor enclosure will have an additional space for fitting an AC-DC electronic power source to power the measurement and transmission of electronics of the PSD, and may also include a communications protocol converter for those installations where this is required.

Description of a preferred embodiment of the system and process for measuring the precision of sun tracking for photovoltaic concentrators

A preferred embodiment of the process for measuring the precision of sun tracking for photovoltaic concentrators takes the form of two-axis trackers with an azimuth elevation configuration such as is normally referred to as the pedestal type, or those which are also common and have an equivalent arrangement of axes, of the gyratory platform type, which are on occasions preferred because of their low profile and greater ease of incorporation into buildings.

The measuring system will comprise:

A pointing sensor as described above (9) fitted in some place in the structure conforming to the collection surface of the concentrator (13), preferably in the parts of that structure which are subject to the least deformation.

A photovoltaic cell mounted in the collection plane of the concentrator and polarized in short circuit (10). Measurement of the short-circuit current of this cell is proportional to the overall irradiance on the collection plane and is used to determine two things:

Discarding measurements of precision of pointing whenever the reading associated with irradiance in the plane is less than a given value initially associated with a screening effect which is greater than that necessary for the intensity of the collimated point of sunlight to be sufficient for the precision of the PSD to be adequate.

Identifying those measurements in which the measured intensity of the collimated point of sunlight in the PSD sensor is less than the value specified for its operation with the rated precision and in any event when the overall irradiance in the collection plane measured by the irradiance cell is higher than the abovementioned value, indicating that the misalignment of the concentrator is greater than the field of view or angular aperture of the pointing sensor.

An anemometer installed on a fixed support on the collection surface of the concentrator, the anemometer being equipped with a tilting mounting in such a way that the plane of the anemometer cups is always horizontal (12). This sensor will be used to measure the wind speed at the perimeter of the collection surface and determine and if necessary correlate these measurements with the misalignment angle measured by the pointing sensor due to structural deformations in the concentrator caused by wind load.

A computer which:

Will communicate with the pointing sensor through a series port. This series port will work with a line protocol sufficient to cover the distances between the measuring sensor and the computer. The samples of the coordinates of the point of collimated sunlight on the surface of the PSD of the pointing sensor will be sent through this port.

Has an integrated data acquisition board for reading the power generated by the photovoltaic concentrator measured from current and voltage measurements. Failing this, one of these variables or the two other polarizations of the concentrator output which can be regarded as equivalent without corresponding to the maximum power point will be measured. Possible alternatives are measurement of the short-circuit current of the concentrator or measurement of the current when the concentrator is polarized at voltages close to the open circuit voltage. This data acquisition board and if appropriate additional signal processing electronics will also be responsible for sampling the measurements from the anemometer and the photovoltaic cell measuring overall irradiance in the abovementioned collection plane.

Auxiliary electronics to control the speed, starting and stopping of the electric motors of the concentrator sun tracker. These electronics could be incorporated into one of the computer's expansion ports, or an external mounting communicating with the computer through one of its serial or parallel ports.

Runs a software application programmed to
a. Permit manual or automatic maximization of the selected electrical variables when the concentrator output is permanently polarized at the point of maximum power or equivalent during the stage of calibrating the pointing sensor, and reading of the corresponding coordinates of the point of collimated sunlight on the surface of the PSD of the pointing sensor when the concentrator has the orientation providing the maximum sought.
b. Be capable of using interpolation techniques to estimate the coordinates of the point of collimated light on the surface of the PSD from positions of this point for orientations in which said maximization is achieved in the case of orientations which do not correspond to those of direct measurements of an output power maximum from the concentrator or an equivalent parameter.
c. Receive the position data for the point of collimated sunlight during the monitoring stage and convert these into the concentrator pointing error angle in real time, using for the purpose the point associated with the maximum power or equivalent as the origin for the coordinates of the plane of the PSD sensor in each orientation, whether measured directly in the orientation in question or estimated by interpolation.
d. Generate statistics for this in real time or subsequent to acquisition on the basis of the time series of stored pointing error angles.
e. Receive overall solar irradiance data in the collection plane and the wind speed during the stage of monitoring, and store them for use in combination with measurements of the pointing error angle, either as a threshold for their acceptance in the case of irradiation or to correlate them in the case of wind speed.

A preferred process for measuring the precision of sun tracking by photovoltaic concentrators is provided using the measurement system described above with two-axis trackers having an azimuth/elevation configuration as follows:
i. First the pointing sensor has to be calibrated with respect to the orientations which generate the maximum electrical power from the concentrator at any moment. The procedure for this is as follows:

As long as the wind speed remains below the predetermined threshold which ensures that calibration can be carried out without significant deformation of the tracking structure due to wind loads and the overall irradiance in the collection plane remains above a predetermined threshold which ensures that the sky is clear and the power generated by the concentrator is significant, the following sequence is performed iteratively:
a. The concentrator is orientated in such a way that the maximum possible output, or other output current or voltage electrical variable from the concentrator output in a polarization of the concentrator which is considered to be equivalent from the point of view of the orientation at which that output is maximized, is produced.
b. When said orientation is found a signal is sent to the computer so that the application software captures the coordinates of the point of incidence of the collimated beam on the surface of the PSD in the pointing sensor, and stores them in memory.
c. In the case of this invention which is preferably a two-axis azimuth/elevation tracker this sequence is repeated for the greatest possible number of orientations in elevation.

Once the set of coordinates for the collimated beam has been recorded in the maximum power production orientations for different elevations, and taking into account the fact that variations will only occur in one of the coordinates of the recorded points, the function for the variation of this coordinate with the elevation of the concentrator in which it was recorded is then generated by interpolation between the points obtained. This function is the one which summarizes calibration of the pointing sensor with respect to the output power of the concentrator at different elevations of its aperture, and acquiring this completes the stage of calibration, which must be carried out at midday in clear skies. The calibration will be more complete the closer to the summer solstice it is carried out, because that is when the range of elevations which can be used for calibration will be greatest.

When the calibration stage is completed the stage of measuring and monitoring the precision of pointing is begun, and this is carried out in three stages:
a. The coordinates of the point of incidence of the collimated light beam on the surface of the PSD are received continuously by the computer via a series communication and stored in memory.
b. Each point will be converted into a pointing angle for that instant and in order to do this it will use the interpolated calibration curve, because for each elevation the origin of coordinates used for conversion will be precisely the one which that curve generates.
c. Pointing error angles will be represented as a time series, together with the probability density of the points of incidence of the collimated beam on the surface of the PSD, by means of the application software run by the computer.

1. A Sensor for Measurement of Precision of Sun Tracking or Pointing for photovoltaic concentrators which comprises:
A PSD (Position Sensitive Device) sensor having two axes generating the planar coordinates of the point of incidence of a beam of collimated light on the surface whereof;
A housing containing within it said PSD sensor incorporating a collimator tube positioned in such a manner that the axis thereof is perpendicular to the surface of such PSD, passing through the center of the surface thereof. Said collimator tube has a cover on its upper part wherein a small aperture is realized solely permitting the passage towards such PSD, situated at the other extreme of the tube, of a thin beam of light when the collimator is pointed at the sun. In such cover there is also incorporated a filter to attenuate the luminous power of the collimated beam impinging on the surface of said PSD such that it lies below the saturation threshold of said sensor. The housing incorporating said collimator tube in one of the surfaces thereof also contains the associated requisite electronics in addition to said PSD sensor; and
Said requisite electronics associated with the PSD, comprising said electronics required to condition the analogue electric signal thereof at measurements and ranges optimum for the transmission thereof. It may also include the requisite electronics for digitization of said conditioned signal and the more robust transmission thereof by means of serial communication protocols. In addition power sources required to supply the consumption of the entirety of the electronics of the Pointing Sensor are incorporated.

2. Equipment for Measurement of Precision of Sun Tracking or pointing for photovoltaic concentrators which comprises:
A Pointing Sensor for photovoltaic concentrators as claimed in claim 1;
A photovoltaic cell installed on the collection surface of such photovoltaic concentrator wherein sun tracking precision is measured and which, short-circuit polarized, functions as overall sun irradiance sensor on such collection surface and serves to discard measurements executed at low irradiance levels due to covered skies;
An anemometer provided with a tilting pendulum-loaded mounting located on the external perimeter of the collection surface of such photovoltaic concentrator wherein sun tracking precision is to be measured, in such a manner that the plane of the cups of said anemometer always remains horizontal whatever the orientation of such collection surface. Said sensor has the function of discarding measurements executed with high wind levels which may cause structural deformation in the photovoltaic concentrator sufficient to degrade the precision of measurement of sun tracking error, or calibration of the sensor of precision of measurement of sun tracking;
A computer provided on the one hand with electronic data-gathering cards having the purpose of:
a. Receiving in real time data of the position of the point of incidence of the beam of collimated sunlight, on the surface of the PSD, from the Pointing Sensor as claimed in claim 1, and in this case such transmission may be arrive in analog form or have been subsequently digitized;
b. Executing measurements of electrical output variables from the photovoltaic concentrator, which inform when said concentrator is orientated at the sun in such a manner as to generate maximum electrical output power;
c. Receiving and processing signals from such anemometer and such photovoltaic cell, having the objective of monitoring exceeding thresholds determined for the corresponding measurement thereof;
Wherein the computer may also be provided with electronic cards permitting direct control of the motors of the tracking axes of the photovoltaic concentrator, including control functionalities of starting, stopping, direction of rotation and speed of such motors, and also receiving measurements of the angle of rotation thereof; and
wherein, in said computer specific programs are executed to process signals and measurements obtained by means of the aforementioned electronic cards, that is to say computation of tracking precision of the concentrator associated therewith, in real time, and presentation thereof in the form of time series, or computation and display of the statistical parameters thereof.

3. A Procedure for Measurement of Precision of Sun Tracking of photovoltaic concentrators which comprises operating in conformity with a method comprising:
A first stage of calibration of such Pointing Sensor as claimed in claim 1, wherein said sensor is calibrated with respect to the maximum power output of the photovoltaic concentrator at differing orientations of its tracking axes, in order to thus take into account the effect of structural deformations on the various operational orientations thereof;
Said calibration stage consists in recording the coordinates of the point of incidence of the collimated beam on the surface of the PSD sensor of the Pointing Sensor as claimed in claim 1, the concentrator pointing perfectly at the sun producing maximum electrical power output, or other electrical measurement which may be considered equivalent thereto when attaining the maximum thereof having identical orientation, the coordinates of said point of incidence are obtained for a significant number of positions of the sun in such manner as to be able to characterize displacements and drifts which this latter may experience at different orientations of the axes of the concentrator due to structural deformations deriving from its own weight;
As post-process product of the calibration stage there is obtained a function of the coordinates of the point of incidence of the collimated beam on the surface of the PSD sensor with the orientation of the two axes of the concentrator. Such function is obtained from the orientations of the coordinates of the position of the point of incidence on the PSD, if actually been measured during the calibration stage, in such a manner that, for orientations at which direct measurements have not been executed, the value of said function is obtained by means of bidimensional interpolation for each of the two coordinates of the point of incidence;
Having this function available, monitoring may be initiated of the precision of sun tracking wherein at each orientation of the concentrator the angle of mispointing thereof is calculated with respect to the local vector of the sun, taking into account the coordinates of the point of incidence of the collimated beam on the PSD which, at such same orientation, produces maximum electrical power in the concentrator, as obtained from the aforesaid function generated in the post-processing of the calibration stage of the Pointing Sensor; and
In such monitoring, measurements require to be made under conditions of wind speed being lower than a predetermined threshold such as to prevent introducing calibration errors arising from structural deformations due to wind load, in addition measurements require to be made under conditions of overall irradiance on the collection plane of the concentrator exceeding a threshold, permitting assuming that the sun is not being occulted by clouds.

4. A Procedure for Measurement of Precision of Sun Tracking achieved by tracking control equipments of hybrid type having auto calibration capacity, permitting preliminary evaluation thereof when operating on the tracker of a given concentrator prior to installation of modules comprising the photovoltaic generator of the concentrator. Such procedure is characterized in that it operates in conformity with a method comprising:
Calibration of the tracking control equipment with respect to the Pointing Sensor as claimed in claim 1, In such calibration the Pointing Sensor is taken as virtual output power from the concentrator the tracking precision whereof is to be evaluated, it being assumed that such output is a maximum when pointing of the Pointing Sensor is perfect, that is to say when the collimated beam impinges on the origin of coordinates of the PSD sensor, Calibration of the control equipment consists in measuring and recording a series of orientations of the tracker for which said maximum virtual power output is achieved, that is to say perfect pointing of the sensor. Such measurements are taken uniformly over time on a day having cloudless skies and may be executed in a manual manner, or such tracking control equipment should automatically be provided with a communications interface with the Pointing Sensor, by employing this set of orientations, characterized by the angles of rotation of the axes of the sun tracker of the concentrator, the error model of the tracking control equipment is adjusted;
Having executed such calibration of the tracking control equipment, monitoring of the sun tracking precision thereof may be initiated, wherein at each orientation of the concentrator the angle of mispointing thereof with respect to the local vector of the sun is calculated taking into account the coordinates of the point of incidence of the collimated beam on the PSD; and
In such monitoring, measurements require to be made under conditions of wind speed being lower than a predetermined threshold such as to prevent introducing calibration errors arising from structural deformations due to wind load, in addition measurements require to be made under conditions of overall irradiance on the collection plane of the concentrator exceeding a threshold, permitting assuming that the sun is not being occulted by clouds.
